(19) United States
(12) Patent Application Publication
(10) Pub. No.: US 2023/0002174 A1
(43) Pub. Date: Jan. 5, 2023

(54) SYSTEMS AND METHODS FOR LOADING, TRANSPORTING, UNLOADING, AND SORTING SHIPPING CONTAINERS USING MAGNETIC LEVITATION

(71) Applicant: ARCTIC CIRCLE IP CORPORATION, Lewes, DE (US)

(72) Inventor: Roger Jay Yang, Lake Forest, CA (US)

(21) Appl. No.: 17/365,945

(22) Filed: Jul. 1, 2021

(51) Int. Cl. B65G 54/02; B65G 63/00; B07C 3/08; B65D 90/00

(52) U.S. Cl. CPC B65G 54/02; B65G 63/004; B07C 3/087; B65D 90/0033

(57) ABSTRACT

Systems and methods for loading, transporting, unloading, and sorting electromagnetic shipping containers using magnetized levitation. The system picks up, rotates, levitates, and propels the electromagnetic shipping containers across a receiving and sorting port. The receiving and sorting port is used to receive and sort shipping containers. The receiving and sorting port includes a container crane for handling multiple shipping containers, simultaneously. The container crane has a spreader that picks up multiple electromagnetic shipping containers at once, including ten-wide set of containers. The electromagnetic shipping container has a first and second set of magnets that work to levitate and propel the containers along a magnetized rail. The magnets repel the force from the magnetized rail, thereby levitating the electromagnetic shipping container. A sortation hub rotates and groups containers according to delivery needs. A surplus yard holds shipping containers during the sorting process. A modular chassis can attach to the shipping containers.

### FIELD OF THE INVENTION

The subject invention generally relates to systems and methods for loading, transporting, unloading, and sorting shipping containers using magnetic levitation. Systems described herein encompass transit between a shipper to a receiver across ports and transport vehicles, such as container ships, semi-trucks, and trains. Magnetic levitation (maglev) methods can be applied to shipping containers to accelerate, rotate, and position containers in ports and transport vehicles. The subject invention may improve energy utilization, transit time, and supply chain management.

### BACKGROUND OF THE INVENTION

The following background information may present examples of specific aspects of anything that can be seen as prior art (e.g., without limitation, approaches, facts, or common wisdom) that, while expected to be helpful to further educate the reader as to additional aspects of what can be seen as prior art, is not to be construed as limiting the present invention, or any embodiments thereof, to anything stated or implied therein or inferred thereupon.

Typically, a container port is a facility where cargo containers are transshipped between different transport vehicles. The transshipment may be between container ships and land vehicles, such as semi-trucks and trains, or other forms of transport. Often found in such a port is a container crane. The container crane is operable to facilitate the transport of containers at the terminal between container ships, a sorting and storage yard, and transport vehicles.

Shipping containers can take many different forms and sizes, from corrugated boxes, to intermediate bulk shipping containers, to intermodal freight containers. Intermodal containers are large durable structures that have standards in dimension, where a 20-foot-long ISO container equals 1 TEU, but there are also forty-foot containers and high cube containers. These are used in intermodal freight transport, meaning these containers can be used across different modes of transport—from ship to rail to truck—without unloading and reloading their cargo. It is significant to note that there are 17 million shipping containers in the world, but only 6 million are used for transport or any other practical usage.

Generally, while loading and unloading container ships, the crane operator must be informed about the set of containers to be loaded or unloaded. Typically, while the stowage plan of a container ship is transmitted electronically from the departure port to the destination port, the crane operator receives cargo lists in paper form before commencing operations. It is thus up to the crane operator alone to decide the sequence of transports between the container ship and each repository location. Another typical approach involves the deck crew on the container ship communicating the desired sequence to the crane operator via radio. These approaches not only increase the demands on personnel, but the overall unloading and loading operations of a container ship become very time-consuming. In either case, the error rate during loading and unloading can be undesirably high. These issues are similar in structure to the travelling salesman problem, but heightened by the differing arrival times of transport vehicles, storage needs, issues of capacity, etc. Modern technologies may be brought to task in optimizing this problem.

Those skilled in the art will recognize that magnetic levitation provides multiple advantages as compared to conventional wheels. Generally, magnetic levitation has low or zero mechanical friction and thus components of maglev systems do not wear nearly as much from mechanical friction or heat. Magnetic levitation has a wide range of speeds over which it can operate, and during operation it generates relatively low noise levels. Electromagnetism is also very precise, as the force is dependent on fields rather than using traditional mechanical tools.

Other proposals have described alternate systems for processing shipping containers. One of the problems with these systems is that they do not utilize magnetic levitation, which was originally patented in 1983. Also, container crane fittings cannot handle multiple containers simultaneously, which limits the overall throughput of the system. Any proposed solution may have to be implemented across the world at different ports, among various transit vehicles, and yet still be a viable capital expenditure for stakeholders.

Across ports and container ships, semi-trucks and trains, global supply chain infrastructure has grown in capacity and complexity through shipping containers. Shipping provisions the world community with the resources necessary for both survival and growth, and the efficiency of the system is essential to daily life and progress. Consider the invention of systems and methods for loading, transporting, unloading, and sorting shipping containers using magnetic levitation. It is significant to note that there are 17 million shipping containers in the world, but only 6 million are used for transport or any other practical usage. Magnetic levitation (maglev) can be employed through rails or a chassis to a plurality of shipping container sizes and packages. Features can include displays for people, batteries, GPS, robotics, and internet connectivity. These systems elevate the utility of a hyperloop and other advanced transportation technologies.

### SUMMARY

Illustrative embodiments of the disclosure are generally directed to systems and methods for loading, transporting, unloading, and sorting electromagnetic shipping containers using magnetized levitation. In one possible embodiment, a gantry crane at a terminal within a port incorporates magnetic levitation in the shipment process. While a container ship is docked, the crane lifts a stack of 5 containers with the assistance of a counterweight and maglev. The crane rotates, orients, levitates, and propels containers through the system to their next transit method or to the storage yard. Rails or a chassis attached to the ISO container interface with a chassis of a semi-truck.

In another embodiment, chassis attached to a container contain systems desired by customers, which may include: displays for communication with personnel and port systems, electricity generation, batteries for independent power, GPS for tracking inventory, radio or satellite or 5G connectivity, computer equipment, lashing rods, water generation, dehumidification, load balancing, temperature control, security tools, weather monitoring, living quarters, and robotic storage. A chassis may increase the height or width of a container to any extent, may allow standardized configurations for non-standard containers, may penetrate to the interior of a container, may span multiple containers, and may perform other functions to be identified.

In another embodiment, the system includes a processing layer in hardware and software to efficiently route from the originating transit node, through intermediary access nodes, to a destination node of transit.

In another embodiment, the container crane may select variable counts of containers from a container ship. A container crane may select a single container, a column of containers stacked 5 high, or a row of containers 10 wide. Stacked containers may be moved as a set, and rows of containers may be moved as a set. A rail or a chassis may span one or more counts of containers.

In another embodiment, in addition to a chassis mounted on to a container, guide rails assist within the system. Guide rails may act to rotate, align, orient, and propel shipping containers using magnetic levitation. A guide rail may also serve to protect a support structure over land, at sea, or in the air. While at sea, chassis and guide rails may assist in maintaining the structural integrity of container stacks.

In another embodiment, instead of a rail, a container has skates fitted to twist locks. A system can be differentiated and specialized for varying operating environments. The skates are designed so that cold weather and frozen ground is the optimal operating environment. When combined with magnetic propulsion, container skates used with guide rails over a frozen surface may achieve rapid propulsion and sustained velocity.

Multiple embodiments may be considered when engineering a particular system implementation, including the use of resources, development time frame, and other considerations of industry. Aspects of embodiments are variable as well and are a challenge to be elucidated fully as shipping is international in scope and subject to local governance, regulation, and other factors.

In one aspect, a system for loading, transporting, unloading, and sorting electromagnetic shipping containers using magnetic levitation, comprises:
multiple electromagnetic shipping containers comprising a floor wall, a roof wall, and multiple side walls,
the floor wall, or the side walls, or both comprising a first set of magnets and a second set of magnets, the first set of magnets operable to enable levitation or lowered friction using electromagnetic fields, the second set of magnets operable to enable generation of propulsive forces;
a receiving and sorting port configured to receive, load, unload, and sort the electromagnetic shipping containers, the receiving and sorting port having:
   a container crane operable to load and unload the electromagnetic shipping containers;
   one or more magnetized floor rails defining a first end, a second end, and a pair of edges, the magnetized floor rails comprising one or more floor magnets arranged to interact with the first set of magnets to generate repulsive and attractive magnetic forces, whereby the electromagnetic shipping containers levitate above the floor rails, whereby the electromagnetic shipping containers are propelled across the floor rails; and
   one or more magnetized guide rails projecting at an orthogonal from the edges of the floor rails, the guide rails comprising one or more guide magnets arranged to interact with the second set of magnets to generate repulsive and attractive magnetic forces, whereby the electromagnetic shipping containers rotate about the floor rails.

In another aspect, the system comprises an electromagnetic coil operatively connected to at least one of the following: the first set of magnets, the second set of magnets, the floor magnets, and the guide magnets.

In another aspect, the electromagnetic coil is configured for selectively enabling interaction between the first and second sets of magnets with the magnetized floor rails.

In another aspect, the electromagnetic coil is configured for selectively enabling interaction between the first and second sets of magnets with the magnetized guide rails.

In another aspect, the system comprises a current portion operatively connected to the electromagnetic coil, the current portion configured to carry an electrical current to the electromagnetic coil.

In another aspect, the system comprises a sortation hub configured for sorting the electromagnetic shipping containers.

In another aspect, the system comprises a surplus yard configured for storing the electromagnetic shipping containers.

In another aspect, the system comprises additional permanent magnets for providing sufficient levitation for the electromagnetic shipping containers and wherein, the additional permanent magnets provide greater magnetic force relative to the floor magnets.

In another aspect, the electromagnetic shipping containers are operable as an electrodynamic suspension.

In another aspect, the first set of magnets have the same magnetic array as the floor magnet.

In another aspect, the second set of magnets have the same magnetic array as the floor magnet.

In another aspect, the container crane comprising a support frame and an arm having a spreader configured to pick up ten or more electromagnetic shipping containers simultaneously.

In another aspect, the magnetized floor rails comprise a flat surface, or a channel, or a canal.

In another aspect, the magnetized guide rails comprise a flat surface, or a channel, or a canal.

In another aspect, the first set of magnets comprise a north pole and a south pole.

In another aspect, the second set of magnets comprise a north pole and a south pole.

In another aspect, the floor magnets comprise a north pole and a south pole.

In another aspect, the guide magnets comprise a north pole and a south pole.

In another aspect, the container crane is operable to load and unload the electromagnetic shipping containers from a container ship to a train or a semi-truck.

In another aspect, the magnetized floor rails are arranged in multiple layers.

Across aspects of embodiments, there are multiple objectives. The overall objective of the present invention is to produce an improved process of transporting electromagnetic shipping containers using magnetic levitation.

An objective is to use natural magnets, electrically charged magnets, metals, alloys, and other matter to move a mass across one or multiple axes.

Another objective is to use rails, gears, arcs, flat surfaces, or other geometric shapes (such as a channel or canal) as mediums by which a mass is transited.

Another objective is to utilize rails or a chassis to protect and/or join with the support structure of the transport vehicle, guide the shipping container to a certain orientation, and control lateral movement or other movements which may damage cargo while at port or at sea.

Another objective is to utilize magnetic levitation to improve the safety of personnel and the public.

Another objective is to use magnetic levitation in shipping to mitigate overall carbon emissions across the industry.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a view of an exemplary system for loading, transporting, unloading, and sorting electromagnetic shipping containers using magnetized levitation, in accordance with an embodiment of the present invention;

FIG. 2 illustrates various graphical projections of electromagnetic shipping containers moving at various speeds and directions, in accordance with an embodiment of the present invention;

FIG. 3 illustrates a diagram of an exemplary electromagnetic shipping container with pairs of north and south poles, in accordance with an embodiment of the present invention;

FIG. 4 illustrates a diagram of a magnetized rail configuration of a central rail and a pair of outer side or guard rails, in accordance with an embodiment of the present invention;

FIG. 5 illustrates a diagram of an exemplary interconnection between five electromagnetic shipping containers, in accordance with an embodiment of the present invention;

FIG. 6 illustrates a flowchart of an exemplary method for loading, transporting, unloading, and sorting electromagnetic shipping containers using magnetized levitation, in accordance with an embodiment of the present invention; and

FIG. 7 illustrates a perspective view of an exemplary chassis with wheels that attaches to the bottom and/or sides of the electromagnetic shipping containers, in accordance with an embodiment of the present invention.

Like reference numerals refer to like parts throughout the various views of the drawings.

### DETAILED DESCRIPTION OF THE INVENTION

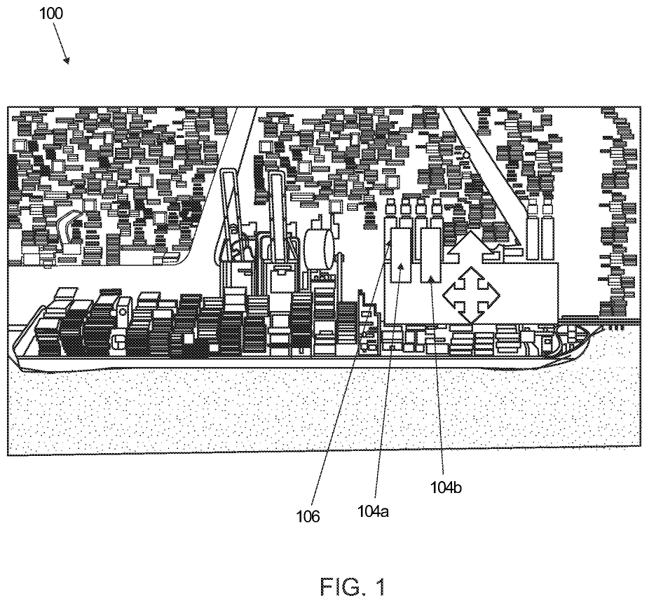

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, summary, or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting unless the claims expressly state otherwise.

A system 100 and method 600 for loading, transporting, unloading, and sorting electromagnetic shipping containers using magnetized levitation is referenced in FIGS. 1-7. The system 100 provides a unique network and technologies for a receiving and sorting port, where multiple shipping containers 202a-e are sorted and transshipped between different transport vehicles, for onward transportation. The receiving and sorting port includes equipment and technologies that enable efficient loading, transporting, unloading, and sorting electromagnetic shipping containers 202a-e along magnetized floor and guide rails, using magnetized levitation.

Looking initially at FIG. 1, the system 100 is configured to handle one or more electromagnetic shipping containers 202a-e from a transport vehicle, i.e., container ship, train, semi-truck, by picking up, rotating, levitating, and propelling the electromagnetic shipping containers 202a-e across a receive and sort port. The system 100 utilizes magnetic levitation with heavy load objects, such as shipping containers 202a-e. Magnetic levitation can use active or passive magnetic interaction for levitation and centering functions, Also, the magnetic levitation can use active or passive magnetic induction for levitation and centering functions; and can utilize electromagnetic fields to iteratively or near-instantaneously propulsive containers.

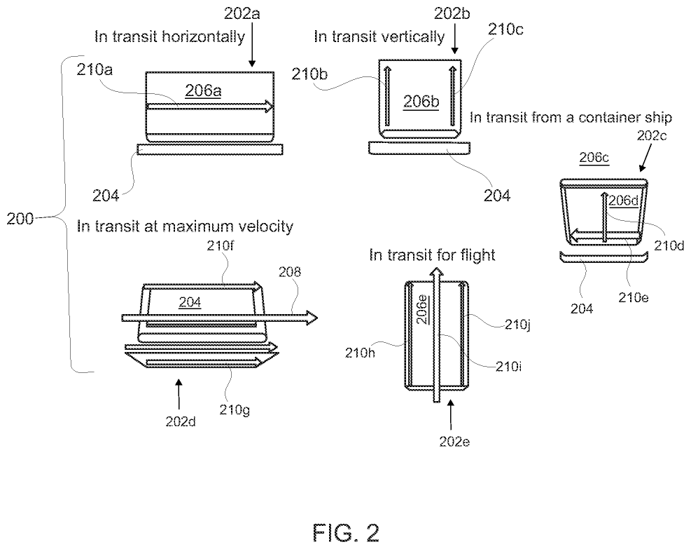

Turning now to FIG. 2, the electromagnetic shipping containers 202a-e are often used for storing goods being transported across long distances. This may include a high cube container having a generally rectangular shape formed from a floor wall 204, a roof wall, and four side walls 206a-e—including a door. In one possible embodiment, electromagnetic shipping containers may include a durable closed steel box about 8′ wide and of either 20′ and 40′ length. In one non-limiting embodiment, the electromagnetic shipping containers are 8′6″ or 9′6″. However, other shapes and dimensions of electromagnetic shipping containers may also be used.

While in the receiving and sorting port, the electromagnetic shipping containers 202a-e can move in various directions and velocities along magnetized rails, utilizing an array of shipping containers 200. As illustrated, electromagnetic shipping containers 202a-e have integrated therein, a first set of magnets 208 and a second set of magnets 210a-j. The magnets 208, 210a-j are integrated into at least one of: the floor wall 204, and the side walls 206a-e. Each set of magnets serves a unique function, as described below.

For example, the floor wall 204 has a first set of magnets 208 operable to generate a repulsive force with magnetized floor rails 104a, 104b to levitate the electromagnetic shipping containers 202a-e. And the side walls 206a-e have a second set of magnets 210a-j operable to generate a repulsive force with magnetized floor rails 104a, 104b to propel the electromagnetic shipping containers 202a-e. In one possible embodiment, the first set of magnets 208 are operable to enable levitation; and the second set of magnets 210a-j operable to enable propulsion.

Thus, as illustrated in FIG. 2, the first and second set of magnets, interacting with the magnetized rails enable the electromagnetic shipping containers to move at different velocities and directions whose orientation can change at the speed of electric transmission. A first electromagnetic shipping container 202a moves across the magnetized rails horizontally. A second electromagnetic shipping container 202b moves across the magnetized rails vertically. A third electromagnetic shipping container 202c is in transit across a transit ship; A fourth electromagnetic shipping container 202d moves across the magnetized rails at maximum velocity; and a fifth electromagnetic shipping container 202e is in transit for flight.

Looking again at FIG. 1, the electromagnetic shipping containers 202a-e are loaded, unloaded, sorted, and prepared for onward transport at a receiving and sorting port. The receiving and sorting port may include a seaport that is configured to receive, load, unload, and sort the electromagnetic shipping containers 202a-e from a container ship. However, the system 100 may utilize other types of ports, terminals, docks, airports, cross-docking facilities, and warehouses. To help unload and load the electromagnetic shipping containers 202a-e, the receiving and sorting port comprises one or more container cranes. The container crane may be a large dockside gantry crane operable to load and unload the electromagnetic shipping containers 202a-e in the receiving and sorting port. In another embodiment, the container crane is operable to load and unload the electromagnetic shipping containers 202a-e from a container ship to a train or a semi-truck. In another embodiment, a container with attached chassis is operable with the container crane.

Significantly, the container crane is unique in being able to handle multiple electromagnetic shipping containers 202a-e at once. To perform this feat, the container crane comprises a support frame and an arm with a spreader. The spreader has a linearly L-shaped member forming a lower transversely dihedral portion with a flaring skirt adapting the spreader to fit around a vertically extending corner of a shipping container. However, in other embodiments, differently known spreader structures may also be used. In some embodiments, the spreader is configured to pick up multiple electromagnetic shipping containers 202a-e at once, including a ten-wide set of containers. In any case, as many as or more than ten shipping containers 202a-e may be picked up simultaneously due to the structure of the spreader.

The container crane can rotate while holding the ten containers with or without the usage of a counterweight. It is known in the art that containers loaded onto a ship may have a different desired orientation than a container attached to a semi-truck. Thus, the rotation of the container is made to an orientation suitable for transit. The spreader has a fulcrum that attaches to the top of the crane, so as to enable 360° rotation. This allows for rotating the shipping containers 202a-e to a desired orientation for further transport across the receiving and sorting port. The spreader can position the ten containers directly onto semi-trucks parked in parallel. In different embodiments, the spreader may be operated automatically, semi-automatically, or manually.

The receiving and sorting port has, extending along the surface, one or more magnetized floor rails 104a, 104b. The magnetized floor rails 104a, 104b may run in multiple directions to different sorting and processing terminals spread out across the receiving and sorting port. In one embodiment, the magnetized floor rails 104a, 104b have a first end and an opposing second end. The magnetized floor rails 104a, 104b also have a pair of edges, at the lateral extremes. In one possible embodiment, the magnetized floor rails 104a, 104b are arranged in multiple layers. This layered effect enhances the effect of the magnets.

To enable the levitation and propulsion of the electromagnetic shipping containers 202a-e, the magnetized floor rails 104a, 104b comprise one or more floor magnets that are arranged to interact with the first set of magnets. This interaction is assisted by the proximity of the floor wall 204 to the magnetized floor rails 104a, 104b, which may be anywhere from a few inches to a few feet, in one exemplary use. In one embodiment, the first set of magnets have the same magnetic array as the floor magnet. In one possible structural configuration, the magnetized floor rails 104a, 104b have at least one of the following configurations: a flat surface, a channel, or a canal.

Similarly, the second set of magnets have the same magnetic array as the floor magnet. In any case, considering the two magnets, each may have a north pole and a south pole. It is known in the art that such opposing poles, inherent in magnets, enable the generation of repulsive and attractive magnetic forces. It is these forces that create the levitation and propulsion of the electromagnetic shipping containers 202a-e. In another embodiment, the floor magnets comprise a north pole and a south pole, which enable repulsion of the opposing poles in the first set of magnets. It is these magnetic forces that enable the electromagnetic shipping containers 202a-e to levitate above the floor rails 104a, 104b.

Through such an arrangement of magnets, the electromagnetic shipping containers 202a-e are propelled across the floor rails 104a, 104b. In this manner, the electromagnetic shipping containers 202a-e are operable as an electrodynamic suspension. In the electrodynamic suspension, there is just one moving part: the electromagnetic shipping container itself. In essence, the electromagnetic shipping container travels along a guideway of magnets which control the train's stability and speed. It is known in the art that both propulsion and levitation of the electromagnetic shipping containers 202a-e require no moving parts. In alternative embodiments, the system 100 comprises additional permanent magnets for providing sufficient levitation for the electromagnetic shipping containers 202a-e. The additional permanent magnets provide greater magnetic force relative to the floor magnets and the guide magnets.

The receiving and sorting port may also have one or more magnetized guide rails 106 projecting at an orthogonal from the edges of the floor rails 104a, 104b. The guide rails 106 comprise one or more guide magnets that are arranged to interact with the second set of magnets in order to generate repulsive and attractive magnetic forces. Through the magnetized guide rails 106, the electromagnetic shipping containers 202a-e can be rotated about the floor rails 104a, 104b. In one embodiment, the guide magnets comprise a north pole and a south pole, which enable repulsion with opposing poles from the second set of magnets.

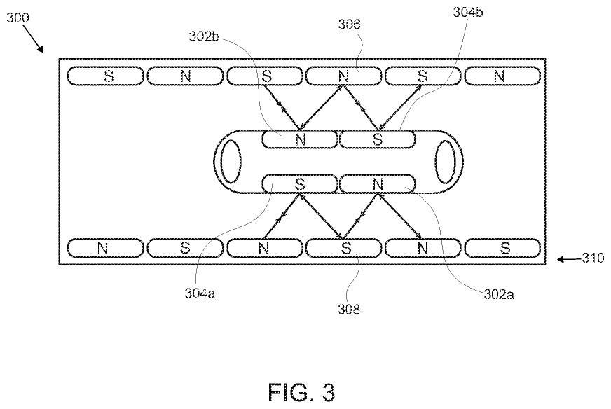

For example, in FIG. 3, an exemplary electromagnetic shipping container 300 with a pair of north poles 302a-b and a pair of south poles 304a-b are referenced. The electromagnetic shipping container 300 rides a magnetized rail 310 having correlating north poles 306 and south poles. The magnetic poles in the electromagnetic shipping container 300 interact with the magnetic poles along the magnetized floor rails 104a, 104b and the magnetized guide rails 106 to create the levitation and propulsion.

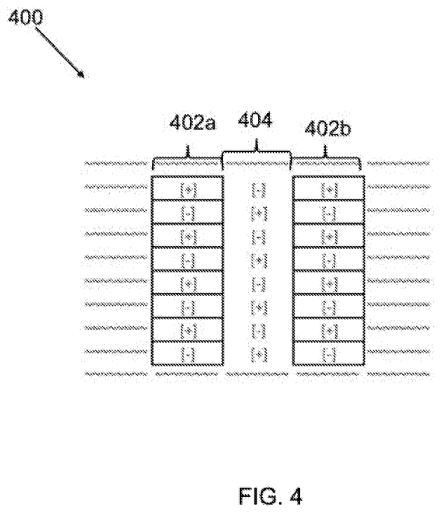

One illustration of exemplary magnetized rails, FIG. 4 shows a magnetized rail configuration 400 of a central rail and a pair of outer side rails 402a-b. The rails are mounted inside a raised mound of dirt, in a sunken channel, or upon a structure above the ground. The side rails 402a, 402b are contained within a concrete culvert. The central rail 404 serves to provide thrust. The side rails 402a-b concentrate on supporting the weight and stabilizing the shipping container. In other possible structures, the magnetized guide rails have at least one of the following configurations: a flat surface, a channel, or a canal.

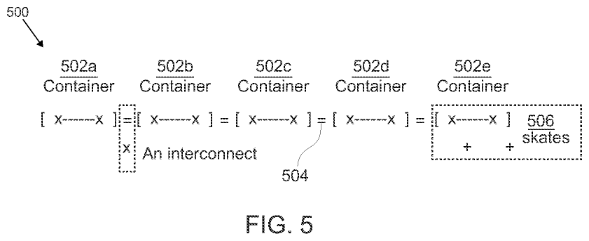

As discussed above, multiple electromagnetic shipping containers are unloaded from the transport vehicle and dropped onto the magnetized rail. Once on the rails, the shipping containers levitate and propel to their next destination in the port. FIG. 5 references a diagram 500 showing an exemplary interconnection 504 of five electromagnetic shipping containers 502a-e. The shipping containers 502a-e connect in a tensile configuration, such that the shipping containers levitate across the rails like a snake on ice. Due to the velocity in transit, an embankment may need to be used. Further, the shipping containers 502a-e are thoroughly insulated to handle changes in temperature. In FIG. 5, “=” stands for the interconnection between shipping containers, “+” stands for skates 506.

In order to regulate and actuate the magnets, the system 100 comprises an electromagnetic coil. The electromagnetic coil is operatively connected to at least one of the following: the first set of magnets, the second set of magnets, the floor magnets, and the guide magnets. In another embodiment, the electromagnetic coil is configured for selectively enabling interaction between the first and second sets of magnets with the magnetized floor rails 104a, 104b. In yet another embodiment, the electromagnetic coil is configured for selectively enabling interaction between the first and second sets of magnets with the magnetized guide rails 106. Additionally, a current portion operatively connects to the electromagnetic coil. The current portion configured to carry an electrical current to the electromagnetic coil. Increasing and decreasing the electrical current serves to increase and decrease the speed of propulsion, and the degree of rotation. This may include a D/C power source.

Looking again at FIG. 1, the system 100 comprises a sortation hub that is configured for sorting the electromagnetic shipping containers 202a-e. In yet another embodiment of the system 100, a surplus yard is utilized. The surplus yard is configured for storing the electromagnetic shipping containers 202a-e. In another exemplary port configuration, the receiving and sorting port includes a processing layer to effectively translate from the first mode of transit (ship, train) to the secondary mode of transit (sorting hub). Other configurations known in the art of transshipping may also be used for efficient movement and sorting of the shipping containers.

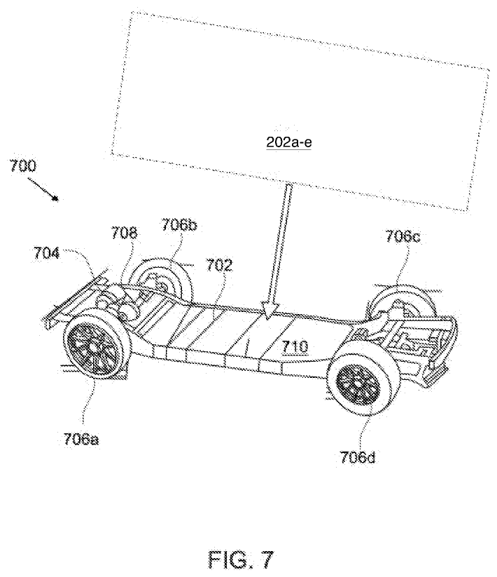

In an alternative embodiment in FIG. 7, the system utilizes a unique modular chassis 700 that attaches to the bottom, top, and/or sides of the electromagnetic shipping containers 202a-e. The modular chassis 700 is configured to carry and guide the electromagnetic shipping containers across the receiving and sorting port, enabling the electromagnetic shipping containers to be received, loaded, unloaded, and sorted. In one embodiment, the modular chassis 700 comprises a platform 702 powered by an electric motor 704. Multiple wheels 706a-d carry the platform 702 and the overlaying electromagnetic shipping container 202a-e. In operation, the electromagnetic shipping containers 202a-e sit on the modular chassis 700 platform architecture, allowing for modular and customizable shipping containers to occupy the space on top.

In additional embodiments, the modular chassis 700 may include a battery 708. In some embodiments, the battery may include a rechargeable battery, such as a lithium-ion battery. The battery 708 is configured to power GPS, electrical, cooling, radio, security, or other types of features that are operable on the electromagnetic shipping containers 202a-e. In one non-limiting embodiment, the battery 708 may be fit within the channels on the electromagnetic shipping containers 202a-e. In this manner, the external volume, or outside volume, is not significantly changed.

In yet another embodiment, the modular chassis 700 comprises a toughened solar panel 710, which may be a thin film, that can withstand the stacking of an electromagnetic shipping container 202a. The solar panel 710 may also be fitted on the sidewalls of the electromagnetic shipping container 202a. In another embodiment, the sidewalls of the electromagnetic shipping container 202a comprise an ultrasound that helps localize the position of cargo within the electromagnetic shipping container 202a. Probes may inspect the constitution of the contents of a container, such as the fluid dynamics or pressure (gasoline, hydrogen). However, when shipping sand or something else, the internal structure of the mass needs monitoring. In another possible embodiment, the modular chassis 700 may be produced on an assembly line, and when it arrives on site, is quickly fastened to one or more of the electromagnetic shipping containers 202a-e. It is significant to note that goods in transit over a year far exceed the value of containers, e.g.: chassis cost at $10 k is $100b for 10 m containers vs $14 tr in global maritime container trade. Lastly, containers are durable goods with a typical lifespan of 10 years, that can be extended with good stewardship.

Those skilled in the art will recognize that containers are lifted from the ship one-by-one. This takes a significant amount of time, with significant duplication of efforts. However, because alternative embodiments of the electromagnetic shipping containers 202a-e can be moved with a counterweight, the force needed to be produced by the crane system is significantly less. Thus, the use of a sufficiently large counterweight can lift a column of containers from a ship.

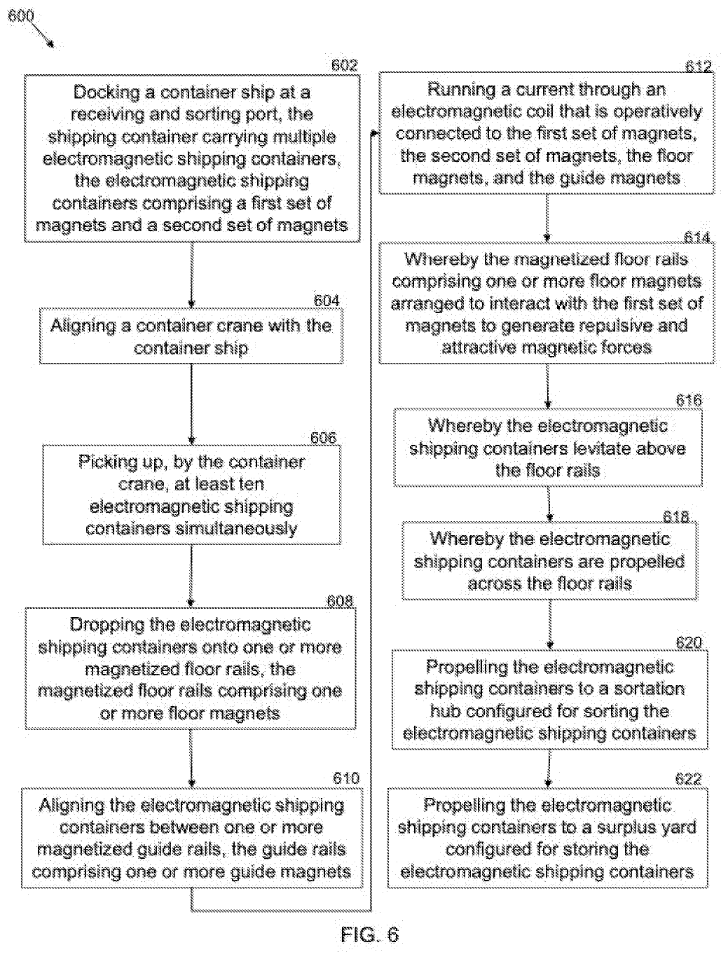

FIG. 6 illustrates an exemplary method for loading, transporting, unloading, and sorting electromagnetic shipping containers using magnetized levitation. The method 600 may include an initial Step 602 of docking a container ship at a receiving and sorting port, the shipping container carrying multiple electromagnetic shipping containers, the electromagnetic shipping containers comprising a first set of magnets and a second set of magnets. The electromagnetic shipping container has a first and second set of magnets that work to levitate and propel the containers along a magnetized rail that utilizes magnetic levitation. The first set of magnets are configured to repel the force from the magnetized rail, thereby levitating the electromagnetic shipping container. Once the electromagnetic shipping container is levitating, a second set of magnets in the electromagnetic shipping container interact with the magnets on the containers to propel the container along the magnetized rail.

The method 600 may further comprise a Step 604 of aligning a container crane with the container ship. A Step 606 includes picking up, by the container crane, at least ten electromagnetic shipping containers simultaneously. However, less than ten containers may also be transported by the crane. In some embodiments, a Step 608 comprises dropping the electromagnetic shipping containers onto one or more magnetized floor rails, the magnetized floor rails comprising one or more floor magnets. The magnetized guide rails are configured to laterally guide, and help rotate, the electromagnetic shipping container. The magnetized guide rails also work to rotate the electromagnetic shipping container to a desired orientation and position to continue the sorting and transporting process. Thus, the magnetized guide rails serve to protect the support structure, guide the container to a certain orientation or precision, and control the lateral movement of the container whether at port or at sea.

In some embodiments, a Step 610 includes aligning the electromagnetic shipping containers between one or more magnetized guide rails, the guide rails comprising one or more guide magnets. In some embodiments, a Step 612 may include running a current through an electromagnetic coil that is operatively connected to the first set of magnets, the second set of magnets, the floor magnets, and the guide magnets. A Step 614 comprises, whereby the magnetized floor rails comprising one or more floor magnets arranged to interact with the first set of magnets to generate repulsive and attractive magnetic forces. A Step 616 comprises, whereby the electromagnetic shipping containers levitate above the floor rails. A Step 618 comprises, whereby the electromagnetic shipping containers are propelled across the floor rails.

The method 600 may further comprise a Step 620 of propelling the electromagnetic shipping containers to a sortation hub configured for sorting the electromagnetic shipping containers. A final Step 622 includes propelling the electromagnetic shipping containers to a surplus yard configured for storing the electromagnetic shipping containers. While in the receive and sort port, the container crane can lift the electromagnetic shipping containers and set them directly on the semi-trucks. A sortation hub may rotate and group containers according to delivery needs. It is significant to note that as a chassis may be expensive, the operator may desire to disconnect a chassis. In this method, chassis may be specialized for particular transit. E.g.: A particular container may always be placed on the top of a stack, and it always has solar and air conditioning as the trade route is sunny and hot. A surplus yard can hold electromagnetic shipping containers during the sorting process. In this manner, magnetized floor rails can elevate a row of containers off a container ship. In this manner, the arm of the crane being able to throw the containers to their next method 600 of transit as rapidly, as a dealer can deal through a deck of cards.

Although the process-flow diagrams show a specific order of executing the process steps, the order of executing the steps may be changed relative to the order shown in certain embodiments. Also, two or more blocks shown in succession may be executed concurrently or with partial concurrence in some embodiments. Certain steps may also be omitted from the process-flow diagrams for the sake of brevity. In some embodiments, some or all the process steps shown in the process-flow diagrams can be combined into a single process.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A system for loading, transporting, unloading, and sorting electromagnetic shipping containers using magnetic levitation, the system comprising:
multiple electromagnetic shipping containers comprising a floor wall, a roof wall, and multiple side walls,
the floor wall, or the side walls, or both comprising a first set of magnets and a second set of magnets, the first set of magnets operable to enable levitation and/or lowered friction using electromagnetic fields, the second set of magnets operable to enable generation of propulsive forces;
a receiving and sorting port configured to receive, load, unload, and sort the electromagnetic shipping containers, the receiving and sorting port having:
a container crane operable to load and unload the electromagnetic shipping containers;
one or more magnetized floor rails defining a first end, a second end, and a pair of edges, the magnetized floor rails comprising one or more floor magnets arranged to interact with the first set of magnets to generate repulsive and attractive magnetic forces, whereby the electromagnetic shipping containers levitate above the floor rails, whereby the electromagnetic shipping containers are propelled across the floor rails; and
one or more magnetized guide rails projecting at an orthogonal from the edges of the floor rails, the guide rails comprising one or more guide magnets arranged to interact with the second set of magnets to generate repulsive and attractive magnetic forces, whereby the electromagnetic shipping containers rotate about the floor rails.

2. The system of claim 1, further comprising an electromagnetic coil operatively connected to at least one of the following: the first set of magnets, the second set of magnets, the floor magnets, and the guide magnets.

3. The system of claim 2, wherein the electromagnetic coil is configured for selectively enabling interaction between the first and second sets of magnets with the magnetized floor rails.

4. The system of claim 3, wherein the electromagnetic coil is configured for selectively enabling interaction between the first and second sets of magnets with the magnetized guide rails.

5. The system of claim 4, further comprising a current portion operatively connected to the electromagnetic coil, the current portion operable to carry an electrical current to the electromagnetic coil.

6. The system of claim 1, wherein the electromagnetic shipping containers are operable as an electrodynamic suspension.

7. The system of claim 1, wherein the first set of magnets comprise a north pole and a south pole.

8. The system of claim 7, wherein the second set of magnets comprise a north pole and a south pole.

9. The system of claim 8, wherein the floor magnets comprise a north pole and a south pole, and the guide magnets comprise a north pole and a south pole.

10. The system of claim 9, wherein the magnetized floor rails are arranged in multiple layers.

11. The system of claim 1, wherein the first and second sets of magnets have the same magnetic array as the floor magnet.

12. The system of claim 1, wherein the magnetized floor rails comprise a flat surface, or a channel, or a canal.

13. The system of claim 1, wherein the magnetized guide rails comprise a flat surface, or a channel, or a canal.

14. The system of claim 1, further comprising additional permanent magnets for providing sufficient levitation for the electromagnetic shipping containers and wherein, the additional permanent magnets provide greater magnetic force relative to the floor magnets.

15. The system of claim 1, further comprising a sortation hub configured for sorting the electromagnetic shipping containers.

16. The system of claim 1, further comprising a surplus yard configured for storing the electromagnetic shipping containers.

17. The system of claim 1, wherein the container crane comprises a support frame and an arm having a spreader configured to pick up ten electromagnetic shipping containers simultaneously.

18. The system of claim 1, further comprising a modular chassis attachable to the electromagnetic shipping containers, the modular chassis comprising a platform powered by an electric motor and multiple wheels or tank treads carrying and guiding the electromagnetic shipping containers across the receiving and sorting port, the modular chassis being less than one inch tall and fastenable to a twist lock.

19. A system for loading, transporting, unloading, and sorting electromagnetic shipping containers using magnetic levitation, the system consisting of:
multiple electromagnetic shipping containers comprising a floor wall, a roof wall, and
multiple side walls,
the floor wall, or the side walls, or both comprising a first set of magnets and a second set of magnets, the first set of magnets operable to enable levitation or lowered friction using electromagnetic fields, the second set of magnets operable to enable generation of propulsive forces,
the first set of magnets comprising a north pole and a south pole,
the second set of magnets comprising a north pole and a south pole;
a receiving and sorting port configured to receive, load, unload, and sort the electromagnetic shipping containers, the receiving and sorting port having:
a container crane operable to load and unload at least ten of the electromagnetic shipping containers, simultaneously;
one or more magnetized floor rails defining a first end, a second end, and a pair of edges, the magnetized floor rails comprising one or more floor magnets arranged to interact with the first set of magnets to generate repulsive and attractive magnetic forces, whereby the electromagnetic shipping containers levitate above the floor rails, whereby the electromagnetic shipping containers are propelled across the floor rails;
one or more magnetized guide rails projecting at an orthogonal from the edges of the floor rails, the guide rails comprising one or more guide magnets arranged to interact with the second set of magnets to generate repulsive and attractive magnetic forces, whereby the electromagnetic shipping containers rotate about the floor rails;
an electromagnetic coil operatively connected to at least one of the following: the first set of magnets, the second set of magnets, the floor magnets, and the guide magnets,
the electromagnetic coil being configured for selectively enabling interaction between the first and second sets of magnets with the magnetized floor rails,
the electromagnetic coil further being configured for selectively enabling interaction between the first and second sets of magnets with the magnetized guide rails;
a current portion operatively connected to the electromagnetic coil, the current portion operable to carry an electrical current to the electromagnetic coil;
additional permanent magnets for providing sufficient levitation for the electromagnetic shipping containers and wherein, the additional permanent magnets provide greater magnetic force relative to the floor magnets and the guide magnets;
a sortation hub configured for sorting the electromagnetic shipping containers; and
a surplus yard configured for storing the electromagnetic shipping containers.

20. A method for loading, transporting, unloading, and sorting electromagnetic shipping containers using magnetic levitation, the method comprising:
docking a container ship at a receiving and sorting port, the shipping container carrying multiple electromagnetic shipping containers, the electromagnetic shipping containers comprising a first set of magnets and a second set of magnets;
aligning a container crane with the container ship;
picking up, by the container crane, at least ten electromagnetic shipping containers simultaneously;
dropping the electromagnetic shipping containers onto one or more magnetized floor rails, the magnetized floor rails comprising one or more floor magnets;
aligning the electromagnetic shipping containers between one or more magnetized guide rails, the guide rails comprising one or more guide magnets;
running a current through an electromagnetic coil that is operatively connected to the first set of magnets, the second set of magnets, the floor magnets, and the guide magnets;
whereby the magnetized floor rails comprising one or more floor magnets arranged to interact with the first set of magnets to generate repulsive and attractive magnetic forces;
whereby the electromagnetic shipping containers levitate above the floor rails;
whereby the electromagnetic shipping containers are propelled across the floor rails;
propelling the electromagnetic shipping containers to a sortation hub configured for sorting the electromagnetic shipping containers; and
propelling the electromagnetic shipping containers to a surplus yard configured for storing the electromagnetic shipping containers.
